(19) United States
(12) Patent Application Publication
(10) Pub. No.: US 2018/0300864 A1
(43) Pub. Date: Oct. 18, 2018

(54) JUDGING APPARATUS, JUDGING METHOD, AND JUDGING PROGRAM

(71) Applicant: FUJITSU LIMITED, Kawasaki-shi (JP)

(72) Inventors: Masayuki Baba, Kawasaki (JP); Susumu HAGA, Hachiouji (JP)

(73) Assignee: FUJITSU LIMITED, Kawasaki-shi (JP)

(21) Appl. No.: 15/949,622

(22) Filed: Apr. 10, 2018

(30) Foreign Application Priority Data
Apr. 12, 2017 (JP) 2017-078863

(51) Int. Cl. G06T 7/00; G06T 7/11; G06K 9/00; G06K 9/62; G06T 7/73

(52) U.S. Cl. CPC G06T 7/001; G06T 7/11; G06T 2207/30164; G06K 9/6211; G06T 7/73; G06K 9/00664

(57) ABSTRACT

A judging method including: obtaining an image of a subject for judgement as a subject image by using an imaging device; judging, by comparing the subject image with a registered image, whether a difference between the subject image and the registered image is greater than or equal to a first threshold; extracting a feature quantity from the subject image and a feature quantity from the registered image if the difference is judged to be greater than or equal to the first threshold; extracting a region of the subject image where a difference in the feature quantity between the region and an associated region of the registered image is greater than or equal to a second threshold; and displaying by a display device the extracted region in the subject image.

### CROSS-REFERENCE TO RELATED APPLICATION

This application is based upon and claims the benefit of priority of the prior Japanese Patent Application No. 2017-78863, filed on Apr. 12, 2017, the entire contents of which are incorporated herein by reference.

### FIELD

The embodiment discussed herein is related to a judging apparatus, a judging method, and a judging program.

### BACKGROUND

It is desirable to automatically judge whether product items are defective or non-defective. To make this judgement, the difference between an image obtained by imaging a product item (subject image) and a registered image used as judgement criteria is utilized. An example of such a technology is disclosed in Japanese Laid-open Patent Publication No. 2016-121980.

In the above-described relate art, although it is possible to judge whether a subject image contains a defective portion, it is difficult to determine which portion of the subject image is defective.

### SUMMARY

According to an aspect of the invention, a judging method including: obtaining an image of a subject for judgement as a subject image by using an imaging device; judging, by comparing the subject image with a registered image, whether a difference between the subject image and the registered image is greater than or equal to a first threshold; extracting a feature quantity from the subject image and a feature quantity from the registered image if the difference is judged to be greater than or equal to the first threshold; extracting a region of the subject image where a difference in the feature quantity between the region and an associated region of the registered image is greater than or equal to a second threshold; and displaying by a display device the extracted region in the subject image

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates subject images of plural product items obtained by using an imaging device;

FIG. 1B illustrates a registered image of a non-defective product item;

FIG. 1C illustrates a subject image of a product item that is found to be defective;

FIG. 2A is a block diagram illustrating the hardware configuration of a judging apparatus according to an embodiment;

FIG. 2B is a schematic view of an imaging device, a manufacturing device, and a product item;

FIG. 3 is a block diagram illustrating functions implemented by executing a judging program;

FIG. 4 is a flowchart illustrating judging processing executed by the judging apparatus;

FIG. 5A illustrates a registered image;

FIG. 5B illustrates a subject image including a defective portion;

FIG. 6A illustrates an example of a registered image divided into rectangular regions;

FIG. 6B illustrates an example of a subject image divided into rectangular regions;

FIG. 7A illustrates regions extracted by a region extractor;

FIG. 7B illustrates an image displayed by a display device;

FIGS. 8A through 8D illustrate an example in which defective/non-defective judgement is made based on the areas of image regions subjected to binarize processing as the feature quantity;

FIGS. 9A through 9F illustrate an example in which two types of feature quantities are used for extracting regions; and

FIGS. 10A through 10F illustrate an example in which regions extracted based on one type of feature quantity and those extracted based on the other type of feature quantity overlap each other.

### DESCRIPTION OF EMBODIMENT

According to an aspect of the embodiment, it is an object of the embodiment to provide a judging apparatus, a judging method, and a judging program that are capable of specifying a defective portion within an image.

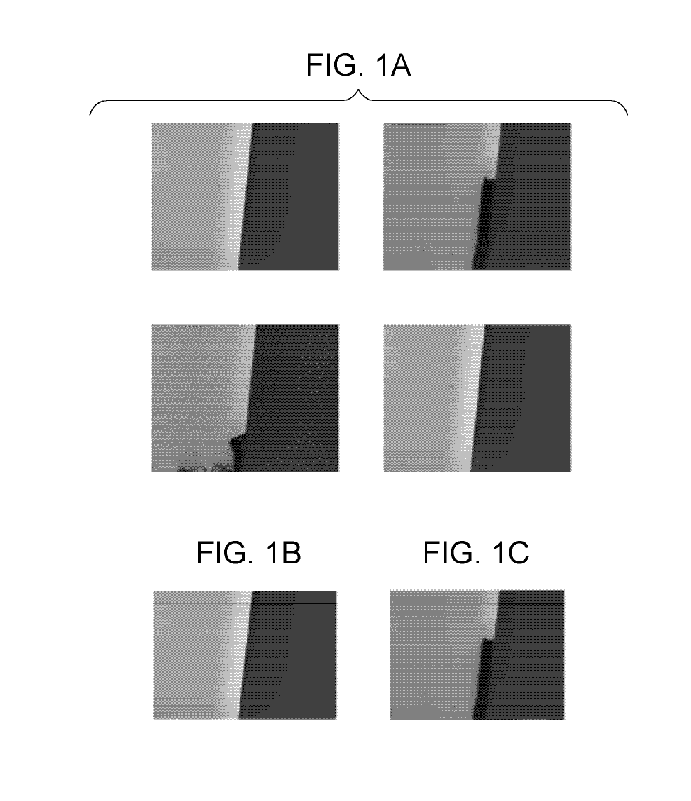

An overview of making a judgement concerning whether product items are defective or non-defective by utilizing images of these product items, for example, will first be discussed below. Before shipping, to automatically judge whether product items are defective or non-defective, images (subject image) obtained by imaging the product items by using an imaging device may be utilized. FIG. 1A illustrates subject images of plural product items obtained by using an imaging device. FIG. 1B illustrates an example of a registered image of a non-defective product item.

A subject image is an image of the entirety or a specific part of a product item. By comparing the subject image of a certain product item with a registered image of a non-defective product item, the difference between the subject image and the registered image is detected. It is then determined whether the difference is greater than or equal to a threshold. Judging of defective product items may be made in this manner. FIG. 1C illustrates a subject image of a product item that is found to be defective. By executing the above-described judging processing by using an image processing program, for example, defective judgement may be performed automatically.

Automatic defective judgement makes it possible to simplify the defective judgement operation. In the defective judgement technology illustrated in FIGS. 1A through 1C, however, it is not indicated which portion of a subject image is defective. According to this technology, although an inspector is able to determine which product item is defective, it is difficult to determine which portion of the product item is defective. In the following embodiment, a judging apparatus, a judging method, and a judging program that are capable of specifying a defective portion within a subject image will be described below.

### Embodiment

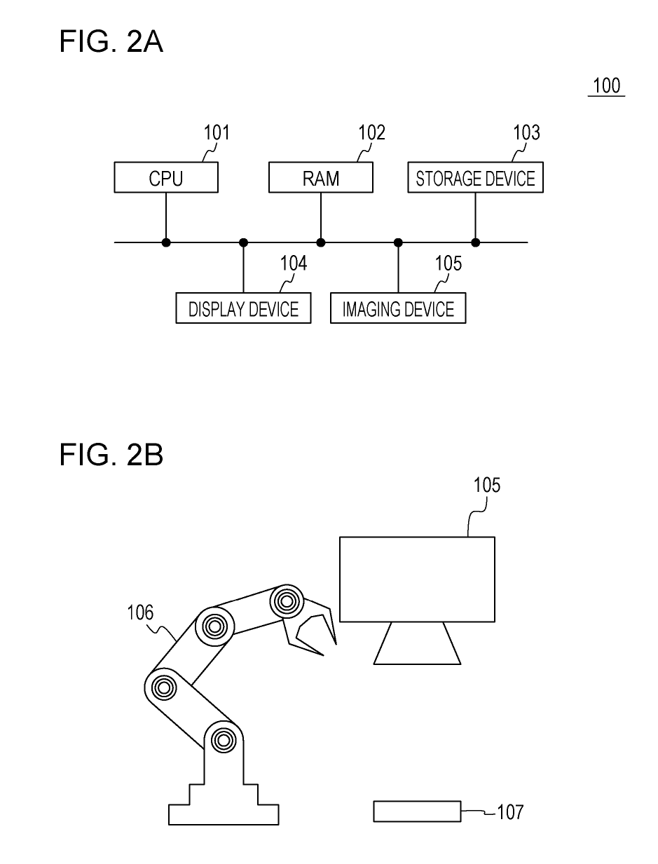

FIG. 2A is a block diagram illustrating the hardware configuration of a judging apparatus 100 according to the embodiment. As illustrated in FIG. 2A, the judging apparatus 100 includes a central processing unit (CPU) 101, a random access memory (RAM) 102, a storage device 103, a display device 104, and an imaging device 105. These elements are connected to each other via a bus, for example.

The CPU 101 includes one or more cores. The RAM 102 is a volatile memory which temporarily stores programs executed by the CPU 101 and data processed by the CPU 101.

The storage device 103 is a non-volatile storage device. Examples of the storage device 103 are a read only memory (ROM), a solid-state drive (SSD) such as a flash memory, and a hard disk driven by a hard disk drive. The judging program according to this embodiment is stored in the storage device 103. Examples of the display device 104 are a liquid crystal display and an electroluminescent panel. The display device 104 displays the results of processing operations, which will be discussed later.

FIG. 2B is a schematic view of the imaging device 105, a manufacturing device 106, and a product item 107. The imaging device 105 images the product item 107 manufactured by the manufacturing device 106 so as to obtain an image of the entirety or a specific part of the product item 107 as a subject image. The imaging device 105 obtains subject images of plural product items 107 by imaging them under the same conditions.

The judging program stored in the storage device 103 is loaded into the RAM 102 so as to be executable. The CPU 101 then executes the judging program loaded into the RAM 102. The judging apparatus 100 is thus able to execute the processing operations.

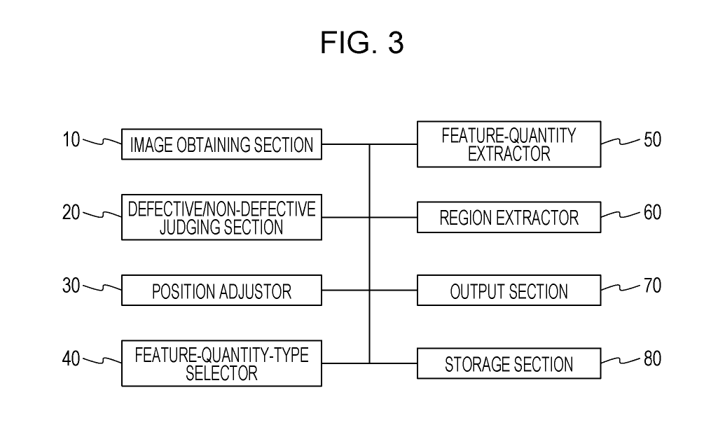

FIG. 3 is a block diagram illustrating the functions implemented by executing the judging program. As illustrated in FIG. 3, executing of the judging program implements an image obtaining section 10, a defective/non-defective judging section 20, a position adjustor 30, a feature-quantity-type selector 40, a feature-quantity extractor 50, a region extractor 60, an output section 70, and a storage section 80. Each of the elements may be constituted by a dedicated circuit, for example.

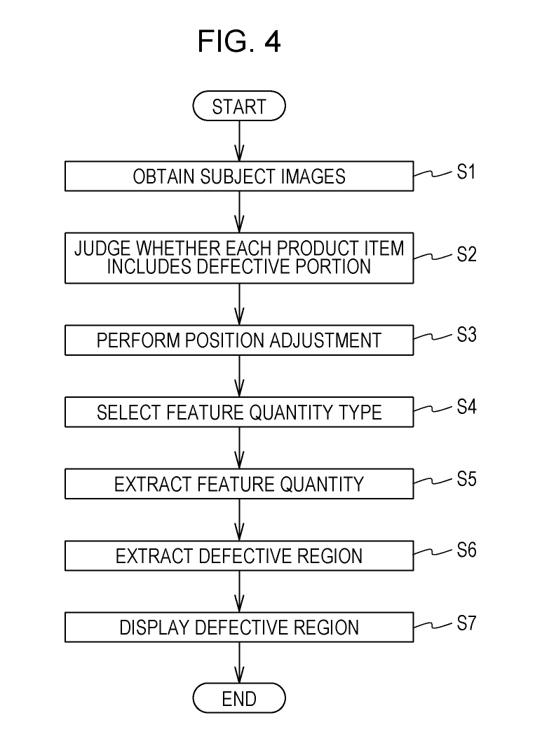

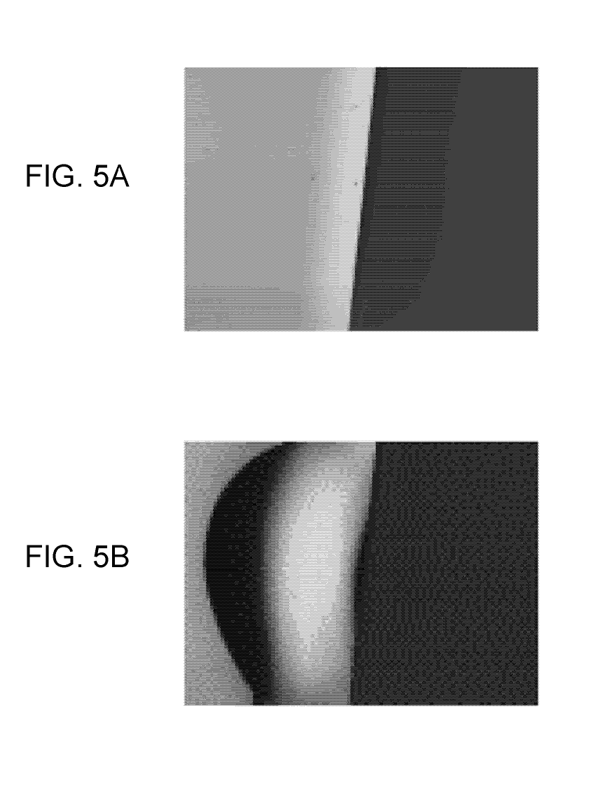

FIG. 4 is a flowchart illustrating judging processing executed by the judging apparatus 100. The judging processing executed by the judging apparatus 100 will be described below with reference to FIGS. 3 and 4. The image obtaining section 10 obtains an image of each product item as a subject image from the imaging device 105 (step S1). The defective/non-defective judging section 20 then reads a registered image stored in the storage section 80 and makes a judgement concerning whether each subject image includes a defective portion by using an algorithm generated by machine learning (step S2). More specifically, the defective/non-defective judging section 20 compares each subject image with the registered image and then judges whether the difference between the subject image and the registered image is greater than or equal to a threshold. FIG. 5A illustrates a registered image. FIG. 5B illustrates a subject image including a defective portion.

The position adjustor 30 adjusts the position of a subject image which is found to include a defective portion to that of the registered image so as to correct the position of the subject image (step S3) to correspond with the registered image. Examples of the position adjustment are translation, rotation, enlargement, and reduction. The feature-quantity-type selector 40 then selects a type of feature quantity to be utilized among plural types of feature quantities (step S4). The feature quantity is a base used for extracting a region of a subject image which is considerably different from the associated region of the registered image. Examples of the feature quantity types are average luminance, edge (image region where the luminance gradient changes sharply), areas of image regions subjected to binarize processing, frequency component peak, and direction component peak.

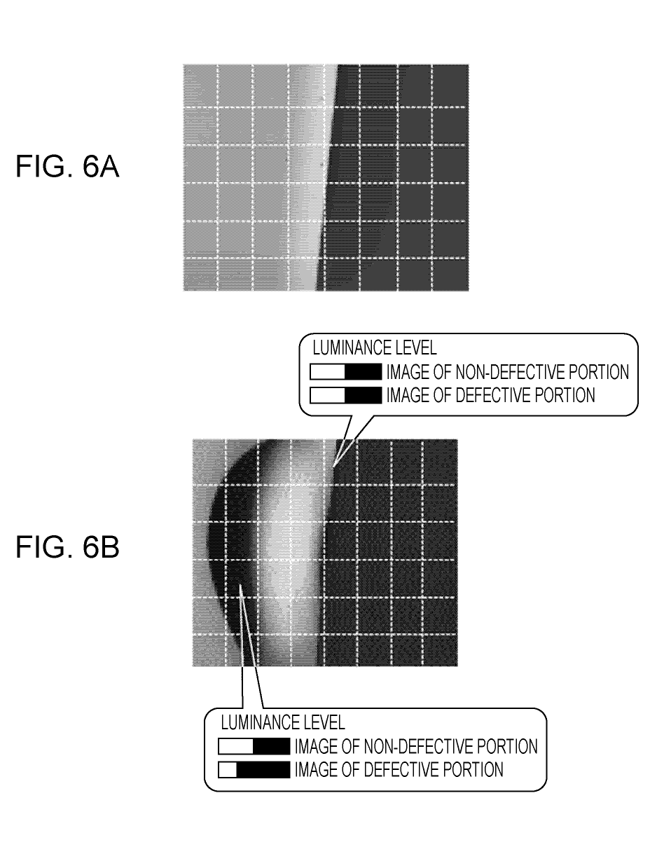

Then, the feature-quantity extractor 50 divides each of the registered image and the subject image into plural regions (rectangular regions, for example) and extracts a feature quantity for each region (step S5). FIG. 6A illustrates an example of the registered image divided into rectangular regions. FIG. 6B illustrates an example of a subject image divided into rectangular regions.

Then, the region extractor 60 extracts corresponding rectangular regions of the subject image and the registered image where the feature quantities are considerably different from each other (step S6). For example, the region extractor 60 extracts a region of the subject image where the difference in the feature quantity is greater than or equal to a threshold or a region of the subject image where the difference in the feature quantity is different from that of the surrounding regions. More specifically, the region extractor 60 may extract a region where the difference in the luminance value (luminance level) is greater than or equal to a threshold (10, for example). The region extractor 60 may alternatively calculate the average difference and the standard deviation for each region and extract a region where the average difference or the standard deviation is 3σ or greater. The region extractor 60 may output plural rectangular regions whose sides or vertices are adjacent to each other as a single group.

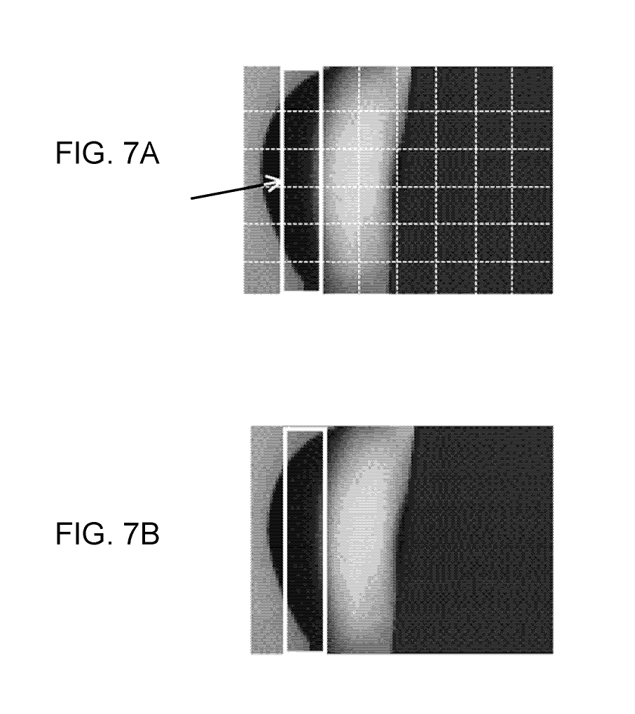

Then, the output section 70 outputs a region extracted by the region extractor 60 to the display device 104 (step S7). The display device 104 displays the subject image and also displays the extracted region within the subject image. FIG. 7A illustrates regions extracted by the region extractor 60. In the example in FIG. 7A, six rectangular regions adjacent to each other are extracted as a group. FIG. 7B illustrates an image displayed by the display device 104.

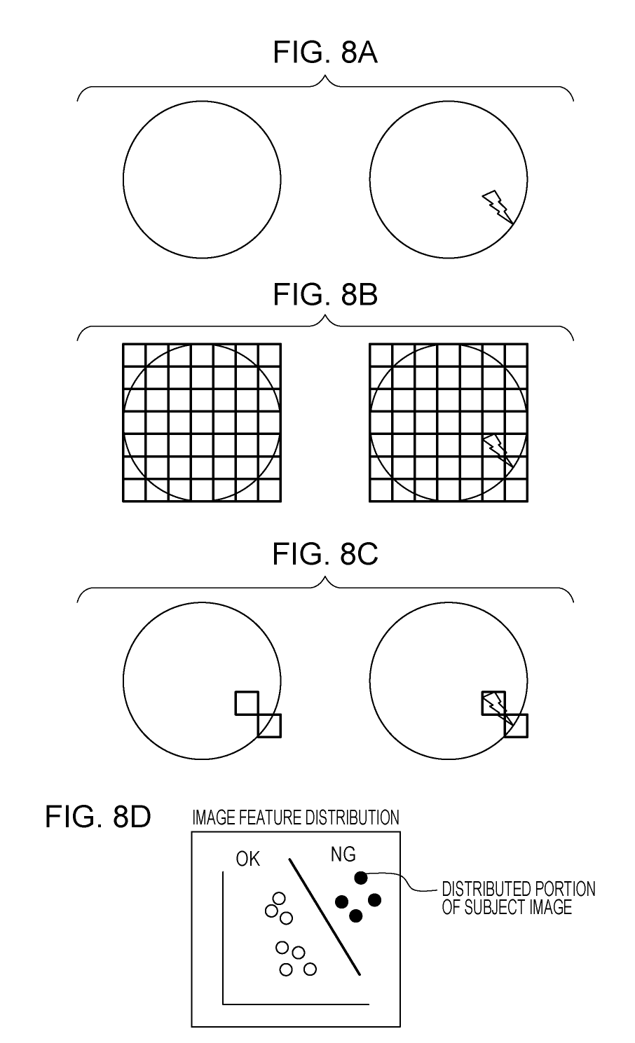

FIGS. 8A through 8D illustrate an example in which defective/non-defective judgement is made based on the areas of image regions subjected to binarize processing (hereinafter called the areas of binarized image regions) as the feature quantity. The judging processing executed based on the areas of binarized image regions will be described below with reference to the flowchart of FIG. 4. The image obtaining section 10 obtains an image of each product item as a subject image from the imaging device 105 (step S1). The defective/non-defective judging section 20 then reads a registered image stored in the storage section 80 and makes a judgement concerning whether each subject image includes a defective portion by using an algorithm generated by machine learning (step S2). The view on the left side of FIG. 8A illustrates a registered image. The view on the right side of FIG. 8A illustrates a subject image including a defective portion.

The position adjustor 30 adjusts the position of a subject image which is found to include a defective portion to that of the registered image so as to correct the position of the subject image (step S3) to correspond with the registered image. The feature-quantity-type selector 40 then selects the areas of binarized image regions from among plural types of feature quantities (step S4).

Then, the feature-quantity extractor 50 divides each of the registered image and the subject image into plural rectangular regions and extracts a feature quantity for each region (step S5). The view on the left side of FIG. 8B illustrates an example of the registered image divided into plural rectangular regions. The view on the right side of FIG. 8B illustrates an example of the subject image divided into plural rectangular regions.

Then, the region extractor 60 extracts associated rectangular regions of the subject image and the registered image where the areas of binarized image regions are considerably different from each other (step S6). For example, the region extractor 60 extracts a region of the subject image where the difference in the area of a binarized image region is greater than or equal to a threshold or a region of the subject image where the difference in the area of a binarized image region is different from that of the surrounding regions. The region extractor 60 may utilize an image feature distribution, such as that illustrated in FIG. 8D. The view on the left side of FIG. 8C illustrates regions of the registered image where the areas of binarized image regions are considerably different from those of the subject image. The view on the right side of FIG. 8C illustrates regions of the subject image where the areas of binarized image regions are considerably different from those of the registered image.

Then, the output section 70 outputs a region extracted by the region extractor 60 to the display device 104 (step S7). The display device 104 displays the subject image and also displays the extracted region within the subject image. In the example in FIG. 8C, two rectangular regions whose vertices are adjacent to each other are extracted as a single group.

According to this embodiment, if it is determined upon comparing a subject image and a registered image that the difference therebetween is greater than or equal to a threshold, the feature quantity of each of the registered image and the subject image is extracted. Then, a region of the subject image where the difference in the feature quantity between this region and the associated region of the registered image is greater than or equal to a threshold is extracted. Then, the extracted region is displayed within the subject image. This configuration enables an inspector to judge whether the subject image contains a defective portion and also to determine which portion of the subject image is defective. Additionally, a portion to be judged whether it is a defective portion is specified within the subject image. The inspector is thus able to easily tell whether the inspector has made a correct judgement for the specified portion.

For example, if a design defect in a product or a portion of a product which may be difficult to manufacture is found, the design department may immediately feed back this information to the upstream side in the production process so as to reduce the product development lead time. Manufacturing operators are able to easily distinguish defective product items from non-defective product items and also to recover product items that have wrongly been determined to be defective. Image processing developers are then able to review filter design and the necessity to conduct machine learning on images, for example. The manufacturing technology department and the quality control department may take certain measures to improve the manufacturing process and the quality and may also stop the release of defective products.

The feature quantity is extracted from a subject image and a registered image after the position of the subject image is adjusted to the registered image. This improves the precision in determining the difference in the feature quantity between the subject image and the registered image.

### Modified Example

In the above-described embodiment, only one type of feature quantity is used for extracting a region of a subject image and that of a registered image where the feature quantities are considerably different from each other. However, two or more different types of feature quantities may be used for extracting a region of a subject image and that of a registered image where the feature quantities are considerably different from each other. In a modified example, two types of feature quantities are used.

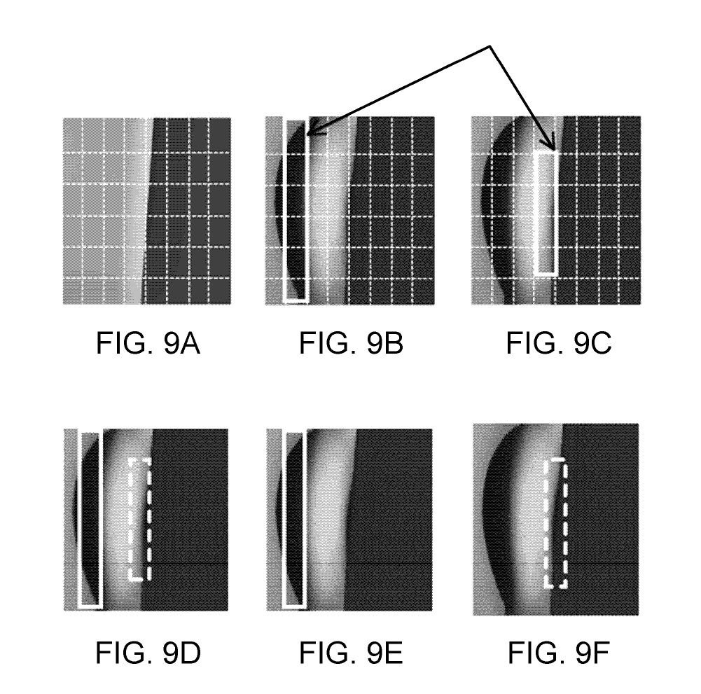

FIG. 9A illustrates a registered image divided into plural rectangular regions by the feature-quantity extractor 50. FIGS. 9B and 9C illustrate subject images divided into plural rectangular regions by the feature-quantity extractor 50. In the example in FIG. 9B, luminance is used as one type of feature quantity, and regions of the subject image where the luminance is considerably different from that of the associated regions of the registered image are extracted. In the example in FIG. 9C, edge is used as the other type of feature quantity, and regions of the subject image where the edge is considerably different from that of the associated regions of the registered image are extracted.

In the case of the use of two types of feature quantities, extracted regions of a subject image where one type of feature quantity is considerably different from that of the associated regions of the registered image may be different from extracted regions of the subject image where the other type of feature quantity is considerably different from that of the associated regions of the registered image. In this case, the output section 70 may output two groups of regions to the display device 104, as illustrated in FIG. 9D. Alternatively, the output section 70 may separately output a group of regions extracted based on the luminance and that extracted based on the edge to the display device 104, as illustrated in FIGS. 9E and 9F. The output section 70 may select regions to be output to the display device 104 in accordance with the selection made by a user using a menu or a button.

The display content may be changed according to the type of feature quantity. For example, as illustrated in FIGS. 9D through 9F, the line type indicating a group of extracted regions may be changed according to the type of feature quantity. Alternatively, the type of feature quantity which has been used for extracting regions may be indicated together with the extracted regions. This enables an inspector to visually understand which type of feature quantity has been used for extracting regions. This kind of displaying is effective when the inspector is able to determine which type of defect is occurring to a product based on the type of feature quantity. If plural types of feature quantities are used, a combination of frequency components and brightness (luminance) is preferably used in terms of the visibility.

According to this modified example, it is possible to display regions extracted based on two or more types of feature quantities. In this case, a region which is not extracted based on only one type of feature quantity may be extracted based on another type of feature quantity and displayed. It is thus less likely that an inspector will omit a defective portion of a product. By changing the display content according to the type of feature quantity, the type of defect may be determined according to the type of feature quantity.

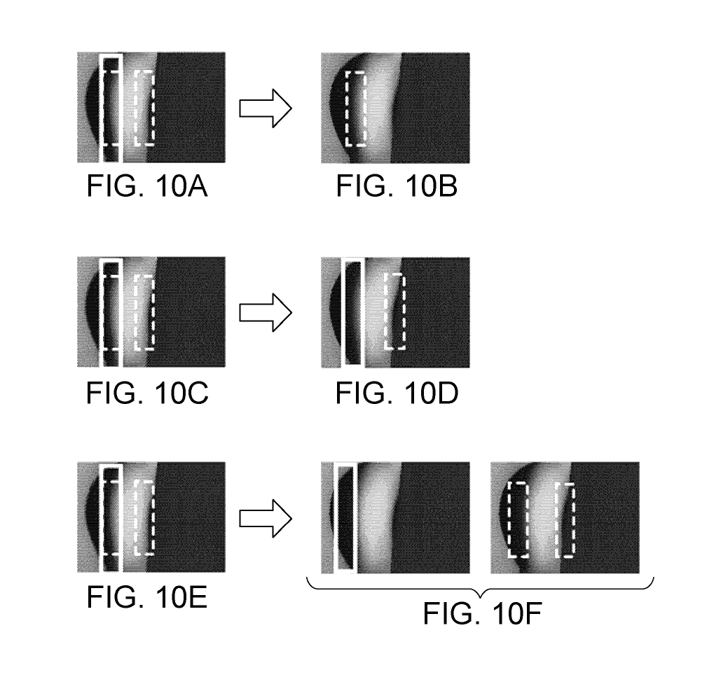

FIGS. 10A through 10F illustrate examples in which regions extracted based on one type of feature quantity and those extracted based on the other type of feature quantity overlap each other. In the examples in FIGS. 10A, 10C, and 10E, the regions surrounded by white solid lines are those extracted based on the luminance, while the regions surrounded by the white dotted lines are those extracted based on the edge. As illustrated in FIGS. 10A, 10C, and 10E, the regions extracted based on the luminance and those based on the edge overlap each other. In this case, the output section 70 may only output overlapping regions (AND regions) to the display device 104, as illustrated in FIG. 10B.

The output section 70 may alternatively output all the extracted regions (OR regions) to the display device 104, as illustrated in FIG. 10D. Alternatively, the output section 70 may separately output regions extracted based on the luminance and those extracted based on the edge to the display device 104, as illustrated in FIG. 10F. The output section 70 may select regions to be output to the display device 104 in accordance with the selection made by a user using a menu or a button.

In the above-described embodiment and modified example, the imaging device 105 serves as an example of an imaging device that obtains an image of a subject for judgement as a subject image. The defective/non-defective judging section 20 serves as an example of a judging section that judges upon comparing the subject image with a registered image whether a difference between the subject image and the registered image is greater than or equal to a threshold. The feature-quantity extractor 50 serves as an example of a feature-quantity extracting section that extracts a feature quantity from the subject image and that from the registered image if the difference between the subject image and the registered image is found to be greater than or equal to the threshold. The region extractor 60 serves as an example of a region extracting section that extracts a region of the subject image where the difference in the feature quantity between the region and an associated region of the registered image is greater than or equal to a threshold. The output section 70 and the display device 104 serve as an example of a display device that displays the region extracted by the region extracting section in the subject image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A judging apparatus comprising:
a memory,
a display, and
a processor coupled to the memory and the display, and configured to:
obtain an image of a subject for judgement as a subject image;
judge, by comparing the subject image with a registered image, whether a difference between the subject image and the registered image is greater than or equal to a first threshold;
extract a first feature quantity from the subject image and a second feature quantity from the registered image if the difference is judged to be greater than or equal to the first threshold;
extract a first region of the subject image where a difference in the first feature quantity and the second feature quantity of a corresponding region of the registered image is greater than or equal to a second threshold; and
display, by the display, the extracted region of the subject image.

2. The judging apparatus according to claim 1, wherein
when extracting the first feature quantity and the second feature quantity, a position of the subject image is adjusted to the registered image, each of the subject image and the registered image is divided into a plurality of regions, and the first feature quantity and the second feature quantity is extracted from each of the plurality of regions of the subject image and the registered image, respectively.

3. The judging apparatus according to claim 1, wherein
when extracting the first feature quantity and the second feature quantity, two or more types of a feature quantity are extracted, and
in the extracting the first region of the subject image, for each of the types of the feature quantity, the first region of the subject image where the difference in the feature quantity of the type between the first region and a corresponding second region of the registered image is greater than or equal to the second threshold is extracted.

4. A judging method comprising:
obtaining, by an imaging device, an image of a subject for judgement as a subject image;
judging, by comparing the subject image with a registered image, whether a difference between the subject image and the registered image is greater than or equal to a first threshold;
extracting a first feature quantity from the subject image and a second feature quantity from the registered image if the difference is judged to be greater than or equal to the first threshold;
extracting a first region of the subject image where a difference in the first feature quantity and the second feature quantity of a corresponding region of the registered image is greater than or equal to a second threshold; and
displaying, by a display device, the first extracted region of the subject image.

5. A non-transitory computer-readable medium storing a judging program for causing a computer to execute a process, the process comprising:
obtaining, by an imaging device, an image of a subject for judgement as a subject image;
judging, by comparing the subject image with a registered image, whether a difference between the subject image and the registered image is greater than or equal to a first threshold;
extracting a first feature quantity from the subject image and a second feature quantity from the registered image if the difference is judged to be greater than or equal to the first threshold;
extracting a first region of the subject image where a difference in the first feature quantity and the second feature quantity of a corresponding region of the registered image is greater than or equal to a second threshold; and
displaying, by a display device, the first extracted region of the subject image.

6. An image processing apparatus comprising:
a processor; and
a memory, the processor coupled to the memory and configured to:
obtain an image of a product by an imaging device,
judge whether the product is defective by comparing the obtained image with a registered product image stored in the memory,
determine whether a difference between the obtained image and the registered image is greater than or equal to a first threshold,
when the product is judged to be defective,
adjust the position of the obtained image to correspond to the position of the registered image,
extract a defective feature quantity from the obtained image and a feature quantity from the registered product image,
extract a defective region of the obtained image where the difference between the defective feature quantity and the feature quantity of the registered image of a corresponding region of the registered image is greater than a second threshold, and
display the extracted defective region of the obtained image on a display device.
